(19) United States
(12) Patent Application Publication
(10) Pub. No.: US 2004/0026016 A1
(43) Pub. Date: Feb. 12, 2004

(54) Lamination embossed image

(75) Inventor: Roger S. Kerr, Brockport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/216,949

(22) Filed: Aug. 12, 2002

(51) Int. Cl. B31F 1/00

(52) U.S. Cl. 156/209; 156/219

(57) ABSTRACT

A method for creating an embossed pre-press proof comprising: laminating a pre-laminate sheet (240); removing the first support layer (150) forming a pre-laminated receiver stock (350); creating an imaged receiver sheet (140) with a second thermal print layer and a second support layer (170); laminating the imaged receiver sheet (140) with the pre-laminated receiver stock (350); removing the second support layer (170) creating a pre-press proof (200); overlaying and laminating a glossy sheet on the pre-press proof forming a glossy pre-press proof (340); removing the glossy sheet (220); overlaying an embossing sheet (180) with an embossed image (190) on the glossy pre-press proof (340) transferring the embossed image to the surface of the glossy pre-press proof (340); and removing the embossing sheet (180).

### FIELD OF THE INVENTION

The present invention relates to the art of color proofing, and in particular, to a method of preparing an embossed pre-press proof, using an embossing sheet and the use of pressure and heat to laminate media together.

### BACKGROUND OF THE INVENTION

Pre-press proofing is a procedure that is used primarily by the printing industry for creating representative images of printed material. In the printing industry pre-press proofs are used to check for color balance, control parameters and other important image quality requirements, without the cost and time that is required to actually produce printing plates, set up a printing press and produce an example of a representative image, which would result in higher costs and a loss of profits that would ultimately be passed on to the customer.

To create a pre-press proof first an original image is separated into individual color separations or digital files. The original image is scanned and separated into the three subtractive primaries and black. Typically a color scanner is used to create the color separations or digital files and in some instances, more than four color separations or digital files are used. Although there are several ways used in the printing industry to create a pre-press proof from the color separations or digital files they are generally one of three types. The first method being a color overlay system that employs the representative image on a separate base for each color, which are then overlaid to create a pre-press proof. The second, a single integral sheet process in which the separate colors for the representative image is transferred one at a time by lamination onto a single base. Third, a digital method in which the representative image is produced directly onto a receiver stock, or onto an intermediate sheet then transferred by lamination onto a receiver stock from digital files.

The representative image to be laminated can be created on, but is not limited to, a commercially available Kodak image processing apparatus, depicted in commonly assigned U.S. Pat. No. 5,268,708, which describes an image processing apparatus having half-tone imaging capabilities. The above-mentioned image processing apparatus is arranged to form a representative image onto a sheet of print media in which colorant from a sheet of colorant donor material is transferred to the print media, by applying a sufficient amount of thermal energy to the colorant donor sheet material to form the representative image. The image processing apparatus is comprised generally of a material supply assembly, a lathe bed scanning subsystem. The scanning subsystem includes: a lathe bed scanning frame, translation drive, translation stage member, printhead, imaging drum, and media exit transports.

The operation of the image processing apparatus comprises of metering a length of the print media (in roll form) from the material supply assembly. The print media is then measured and cut into sheet form of the required length and transported to the imaging drum, registered, wrapped around, and secured onto the imaging drum. Next a length of colorant donor material (in roll form) is also metered out of the material supply assembly, then measured and cut into sheet form of the required length. It is then transported to the imaging drum. Wrapped around the imaging drum utilizing a load roller which is described in detail, in commonly assigned U.S. Pat. No. 5,268,708, such that it is superposed in the desired registration with respect to the print media (which has already been secured to the imaging drum).

After the colorant donor sheet material is secured to the periphery of the imaging drum the scanning subsystem or write engine provides the imaging function. This image function is accomplished by retaining the print media and the colorant donor sheet material on the imaging drum while it is rotated past the printhead. The translation drive traverses the printhead and translation stage member axially along the axis of the imaging drum, in coordinated motion with the rotating imaging drum. These movements combine to produce the representative image on the print media.

Once the representative image has been formed on the print media, the colorant donor sheet material is then removed from the imaging drum. This is accomplished without disturbing the print media that is beneath it. The colorant donor sheet material is then transported out of the image processing apparatus by means of the material exit transport. Additional colorant donor sheet materials featuring other desired colorants are sequentially superimposed with the print media on the imaging drum and then imaged onto the print media as previously mentioned, until the representative image is completed on the print media. The representative image formed thereon is then unloaded from the imaging drum and transported by the receiver sheet material exit transport to an exit tray in the exterior of the image processing apparatus.

After a representative image has been formed on the print media as previously described it is transferred to a receiver stock such that the pre-press proof is representative of the intended image to be printed on a printing press. A Kodak laminator as described in U.S. Pat. No. 5,478,434 can be used to bond or laminate the representative image as a part of a pre-press proofing system. As additional references U.S. Pat. No. 5,203,942 describes a Kodak laminator that employs a lamination/de-lamination system as applied to a drum laminator and pending U.S. patent application Ser. No. 09/676,877, filed Sep. 29, 2000, describes a Kodak laminator that employs endless belts incorporated into the lamination apparatus. For the purpose of this patent application the laminator described in U.S. patent application Ser. No. 09/676,877 will be used. It should be noted that the present invention described in this disclosure is not limited to a Kodak laminator or type of laminator referenced above.

The receiver stock can be sheet-fed press printing stock, specially coated paper stock, or previously laminated stock. In this latter case a sheet of pre-laminate, which has a pre-laminate support layer consisting of a suitable base material, optionally coated with a releasing material, and a thermal print layer, is placed on top of a receiver sheet, which is also called receiver stock in the industry. This construction of multiple layers is a lamination sandwich, which is fed into the laminator. Once the lamination sandwich exits the laminator the pre-laminate support layer is peeled away from the now pre-laminated receiver stock. Any of the laminators referred to above can be used to affect the transfer of the pre-laminate receiving layer to the receiver stock.

Although the above described lamination method works well for most materials and both laser thermal and ink jet pre-press proofs. There exists a need for laminating a wider variety of pre-press proofs such as an embossed pre-press proof to have appear to have a hologram or foil effect used in the graphics packaging market.

### SUMMARY OF THE INVENTION

The present invention relates to a method for forming an embossed pre-press proof using an embossing sheet to create an embossed pre-press proof.

Specifically the method relates to a series of steps for creating an embossed pre-press proof comprising: creating a pre-press proof having an image formed thereon; embossing the surface of the pre-press proof by overlaying and laminating the pre-press proof with an embossing sheet having an embossing image thereon; removing the embossing sheet and thereby forming an embossed pre-press proof.

In an alternative embodiment, the invention relates to a method for creating an embossed pre-press proof comprising the steps of: creating a pre-press proof having an image formed thereon; overlaying and laminating the pre-press proof with a plastic cover sheet forming an over laid pre-press proof; embossing the surface of the overlaid pre-press proof by overlaying and laminating the overlaid pre-press proof with an embossing sheet having an embossing image thereon; removing the embossing sheet forming an embossed pre-press proof.

In another alternative embodiment, the invention relates to a method for creating an embossed pre-press proof comprising: creating an imaged receiver sheet having a support layer and a print layer having an image formed on the print layer; laminating said imaged receiver sheet to a sheet of receiver stock; removing the support layer creating a pre-press proof; overlaying and laminating the pre-press proof with a glossing sheet; removing the glossing sheet forming a glossy pre-press proof; embossing the surface of the glossy pre-press proof by overlaying and laminating the glossy pre-press proof with an embossing sheet having an embossing image thereon; removing the embossing sheet forming an embossed pre-press proof.

In another alternative embodiment, the invention relates to a method for creating an embossed pre-press proof comprising: laminating a pre-laminate sheet consisting of a first print layer, and a first support layer to a receiver stock; removing the first support layer forming a pre-laminated receiver stock; creating an imaged receiver sheet with a second support layer and a second print layer having an image formed on the second print layer; laminating the imaged receiver sheet to the pre-laminated receiver stock; removing the second support layer creating a pre-laminated pre-press proof; overlaying and laminating a glossing sheet to the pre-laminated pre-press proof; removing the glossing sheet forming a pre-laminated glossy pre-press proof; embossing the surface of the pre-laminated glossy pre-press proof by overlaying and laminating an embossing sheet having an embossing image thereon with the pre-laminated glossy pre-press proof; removing the embossing sheet forming an embossed pre-press proof.

In another alternative embodiment, the invention relates to a method for creating a dual embossed imaged pre-press proof comprising an imaged pre-press proof with a first side and a second side and an image formed on at least one of the sides, creating a first embossing sheet by forming a first embossing impression and creating a second embossing sheet by forming a second embossing impression, disposing of the first embossing sheet on the first side of the imaged pre-press proof and the second embossing sheet on the second side of the imaged pre-press proof and laminating the imaged pre-press proof with the first and second embossing sheets and removing the first and second embossing sheets forming a dual embossed imaged pre-press proof.

In another alternative embodiment, the invention relates to a method for creating a reinforced dual embossed imaged pre-press proof comprising creating an imaged pre-press proof comprising an image formed, overlaying and laminating the imaged pre-press proof with a plastic cover sheeting forming and overlaid imaged pre-press proof having a first side and a second side; creating a first embossing sheet by forming a first embossing impression and creating a second embossing sheet by forming a second embossing impression; disposing the first embossing sheet on the first side of the overlaid imaged pre-press proof and the second embossing sheet on the second side of the overlaid imaged pre-press proof and laminating the overlaid imaged pre-press proof with the first and second embossing sheets; and removing the first and second embossing sheets forming a reinforced dual embossed imaged pre-press proof.

In another alternative embodiment, the invention relates to a method for creating a dual embossed glossy pre-press proof comprising creating a imaged receiver sheet comprising a support layer and a print layer comprising an image, laminating the imaged receiver sheet to a sheet of receiver stock, removing the support layer creating a pre-press proof, overlaying and laminating the pre-press proof with a glossing sheet, removing the glossing sheet forming a glossy pre-press proof having a first side and a second side, creating a first embossing sheet by forming a first embossing impression and creating a second embossing sheet by forming a second embossing impression; disposing the first embossing sheet on the first side of the glossy pre-press proof and the second embossing sheet on the second side of the glossy pre-press proof and laminating the overlaid imaged pre-press proof with the first and second embossing sheets; and removing the first and second embossing sheets forming a dual embossed glossy pre-press proof.

In another alternative embodiment, the invention relates to a method for creating a dual embossed glossy pre-press proof comprising laminating a pre-laminate sheet consisting of a first print layer and a first support layer to a receiver stock; removing the first support layer forming a prelaminated receiver stock; creating a imaged receiver sheet comprising a second support layer and a second print layer comprising an image; laminating the imaged receiver sheet to the prelaminated receiver stock; removing the second support layer creating a pre-laminated pre-press proof; overlaying and laminating a glossing sheet to the prelaminated pre-press proof; removing the glossing sheet forming a prelaminated glossy pre-press proof having a first side and a second side; creating a first embossing sheet by forming a first embossing impression and creating a second embossing sheet by forming a second embossing impression; disposing the first embossing sheet on the first side of the prelaminated glossy pre-press proof and the second embossing sheet on the second side of the prelaminated glossy pre-press proof and laminating the prelaminated pre-press proof with the first and second embossing sheets; and removing the first and second embossing sheets forming a dual embossed glossy pre-press proof.

### BRIEF DESCRIPTION OF THE DRAWINGS

FIG. 1 is a perspective view showing a laminator known in the related are used with the present invention.

FIG. 2 is a schematic right side elevation of the laminator of FIG. 1.

FIG. 3 is a block diagram showing one embodiment of the method for producing an embossed pre-press proof of the invention.

FIG. 4 is a block diagram showing another embodiment of the method for producing an embossed pre-press proof of the invention.

FIG. 5 is a block diagram showing another embodiment of the method for producing an embossed pre-press proof of the invention.

FIG. 6 is a block diagram showing another embodiment of the method for producing an embossed pre-press proof of the invention.

### DETAILED DESCRIPTION OF THE INVENTION

The invention has been described in detail with particular reference to certain preferred embodiments thereof, but it will be understood that variations and modifications can be effected within the spirit and scope of the invention. For the sake of discussion, but not limitation, the preferred embodiment of the present invention will be illustrated in relation to a laminating apparatus for making pre-press proofs. Referring to the drawings wherein like reference numerals represent identical or corresponding parts throughout the several views.

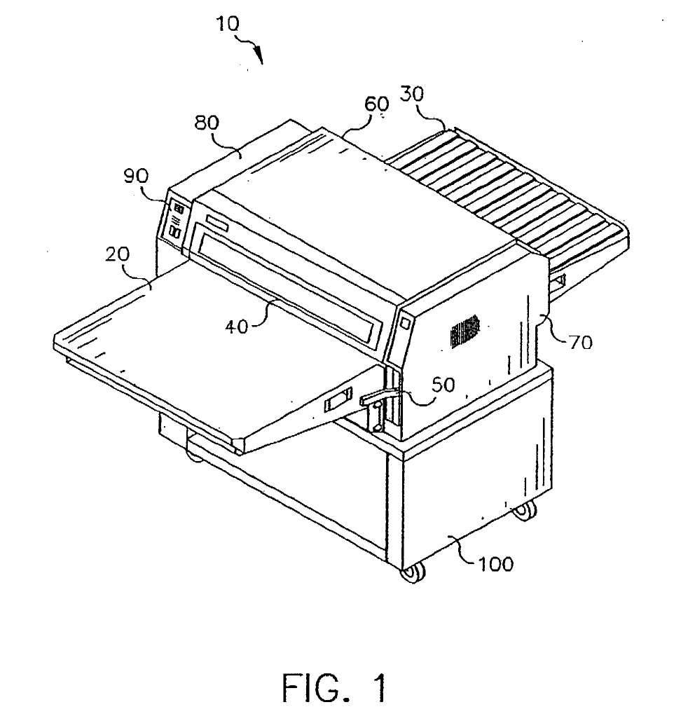

Referring to FIG. 1, there is shown perspective view of laminator 10 as described in U.S. patent application Ser. No. 09/676,877. The laminator 10 has an entrance table 20, exit table 30, entrance slot 40, pressure lever 50, top cover 60, right side cover 70, left side cover 80, control panel 90, and lamination base 100.

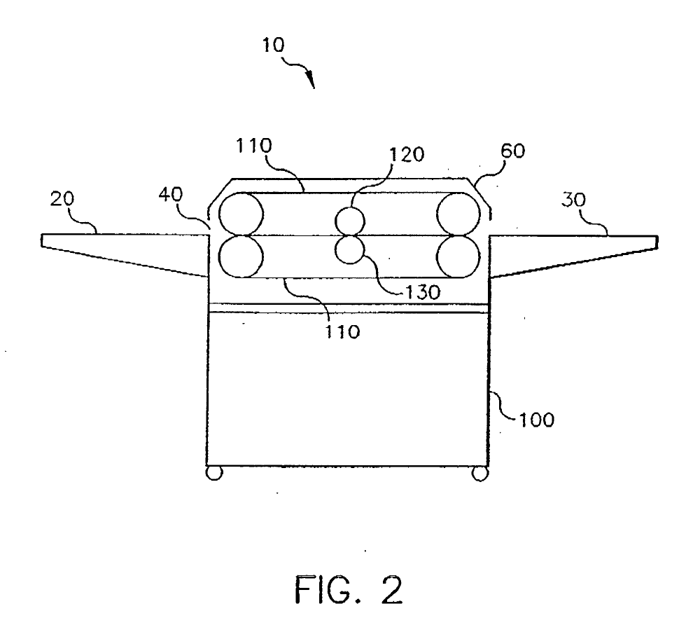

FIG. 2 is a schematic right side elevation of the laminator of FIG. 1 showing endless belts 110 with upper lamination roller 120 and lower lamination roller 130 which convey the media to be laminated through the laminator 10. Media to be bonded or laminated passes between the endless belts 110. Upper lamination roller 120 and lower lamination roller 130 provide heat and pressure to laminate the desired media together. This configuration with upper lamination roller 120 and lower lamination roller 130 is called a “straight-through” laminator. Although the illustrated embodiments show both the upper lamination roller 120 and lower lamination roller 130 as heated pressure rollers, it also should be recognized that only one of the upper lamination roller 120 and lower lamination roller 130 may be heated. It is further recognized that both upper lamination roller 120 and lower lamination roller 130 do not have to be heated for cold lamination applications.

The following methods are usable for forming a pre-press proof 200 with a resolution of between about 1000 dpi and 4000 dpi, although in the most preferred embodiment, the high resolution is between 1200 dpi and 3600 dpi. The image can be initially created on print media 320 with an ink jet printer, laser printer, or any other printing method known in the art.

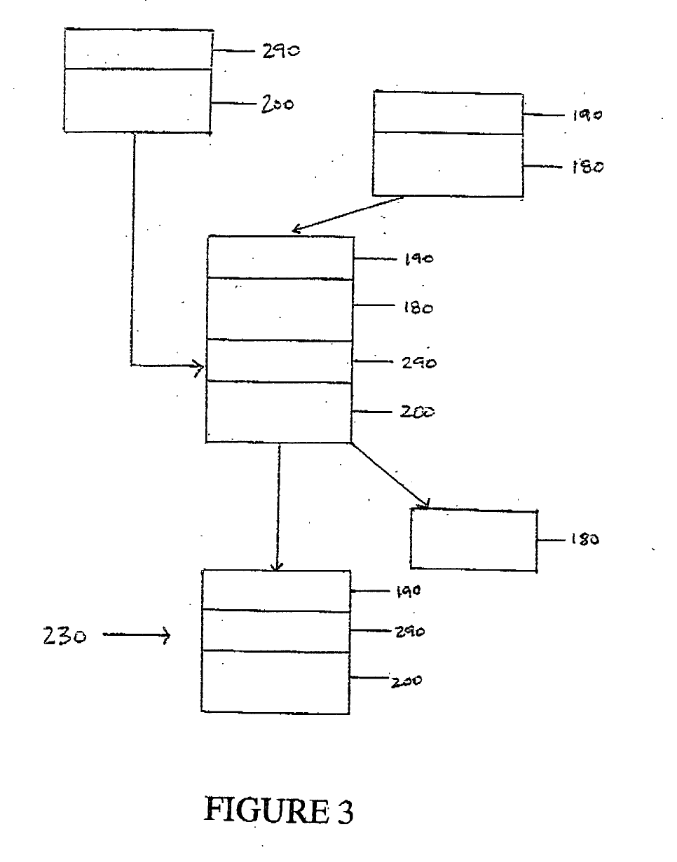

Referring to FIG. 3 a block diagram is shown outlining a method for producing an embossed pre-press proof 230 comprising the steps of: creating a pre-press proof 200 having an image 290 formed thereon; embossing the surface of the pre-press proof 200 by overlaying and laminating the pre-press proof 200 with an embossing sheet 180 having an embossing image 190 thereon; removing the embossing sheet 180 forming an embossed pre-press proof 230.

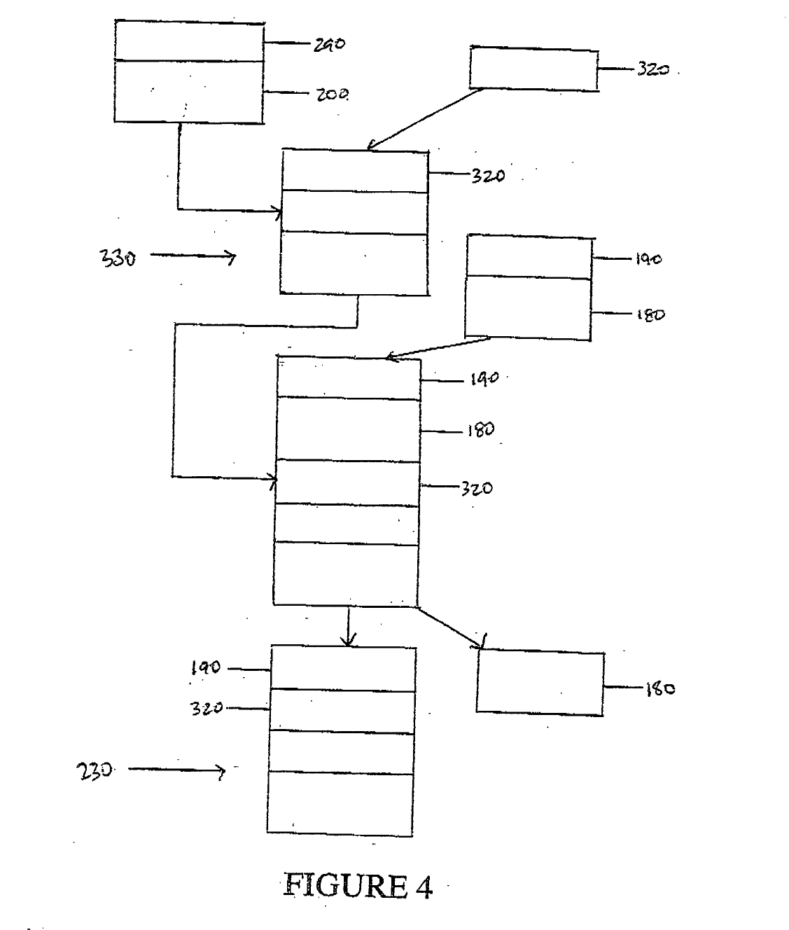

Referring to FIG. 4 a block diagram is shown outlining an alternative embodiment of the invention. In this embodiment, the invention relates to a method for creating an embossed pre-press proof 230 comprising the steps of: creating a pre-press proof 200 having an image 290 formed thereon; overlaying and laminating the pre-press proof 200 with a plastic cover sheet 320 forming an overlaid pre-press proof 330; embossing the surface of the overlaid pre-press proof 330 by overlaying and laminating the overlaid pre-press proof 330 with an embossing sheet 180 having an embossing image 190 thereon; removing the embossing sheet 180 forming an embossed pre-press proof 230.

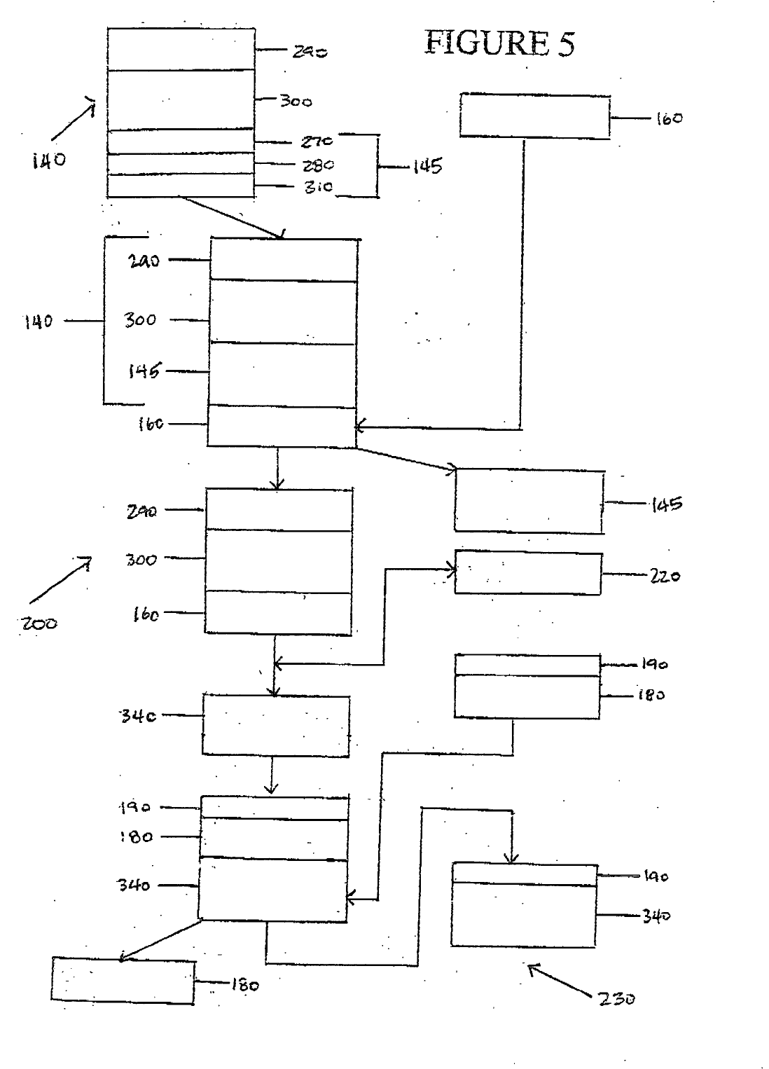

Referring to FIG. 5 a block diagram is shown outlining another alternative embodiment of the invention. The invention relates to a method for creating an embossed pre-press proof 230 comprising the steps of: creating an imaged receiver sheet 140 having a support layer 145 comprising release layer 270, aluminized layer 280 and a support base 310 combinations there of or just a support base 310, and a print layer 300 having an image 290 formed on the print layer 300; laminating the imaged receiver sheet 140 to a sheet of receiver stock 160; removing the support layer 145 creating a pre-press proof 200; overlaying and laminating the pre-press proof 200 with a glossing sheet 220; removing the glossing sheet 220 forming a glossy pre-press proof 340; embossing the surface of the glossy pre-press proof 340 by overlaying and laminating the glossy pre-press proof 340 with an embossing sheet 180 having an embossing image thereon 190; removing the embossing sheet 180 forming an embossed pre-press proof 230.

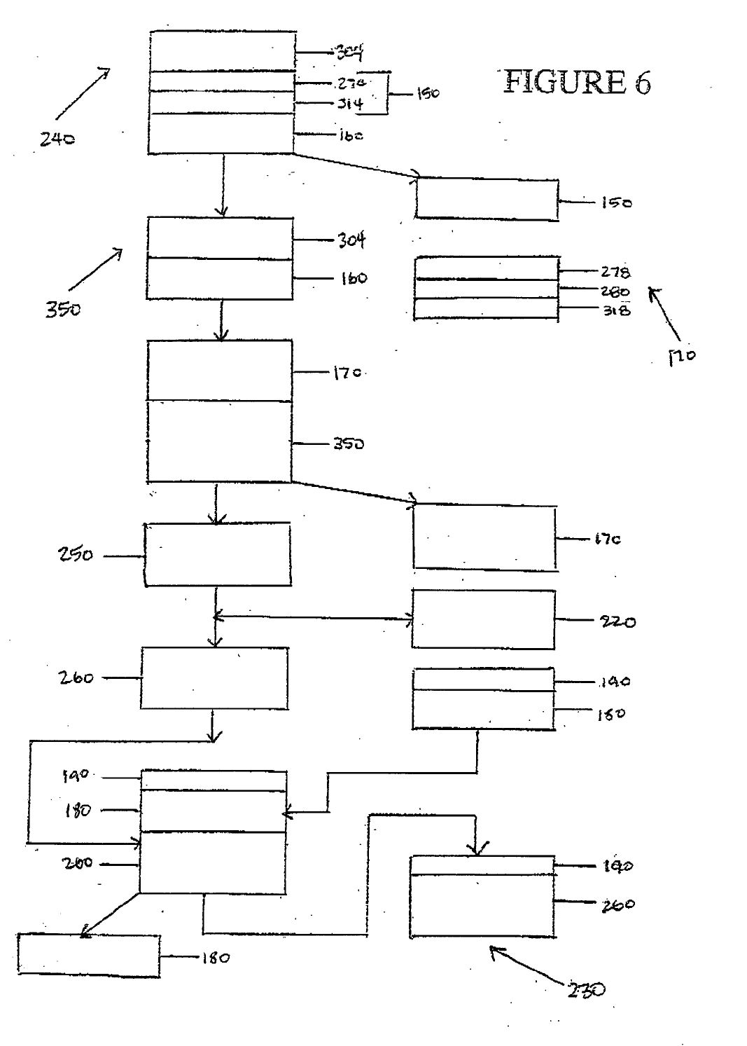

Referring to FIG. 6 a block diagram is shown outlining another alternative embodiment of the invention. In this embodiment, the invention relates to a method for creating an embossed pre-press proof 230 comprising the steps of: laminating a pre-laminate sheet 240 consisting of a first print layer 304, and a first support layer 150 having a first release layer 274 and a first support base 314 or alternatively, just a first support base 314, to a receiver stock 160; removing the first support layer 150 forming a pre-laminated receiver stock 350; creating a second support layer 170 comprising second release layer 278, aluminized layer 280 and a second support base 318 combinations there of or just a second support base 318; laminating the second support layer 170 to the pre-laminated receiver stock 350; removing the second support layer creating a pre-laminated pre-press proof 250; overlaying and laminating a glossing sheet 220 to said pre-laminated pre-press proof 250; removing the glossing sheet 220 forming a pre-laminated glossy pre-press proof 260; embossing the surface of the pre-laminated glossed pre-press proof 260 by overlaying and laminating an embossing sheet 180 having an embossing image 190 thereon with the pre-laminated glossy pre-press proof 260; removing the embossing 180 sheet forming an embossed pre-press proof 230.

The invention contemplates the formation of an embossed pre-press proof 230 with an image resolution of between about 1000 dpi about 4000 dpi using the above described methods, although the more preferred resolution is expected to be between about 1200 dpi and about 3000 dpi.

Additionally, it is contemplated; that the image 290 formed on imaged receiver sheet 140 can be either monochrome or a multi colored, that the image 290 of the imaged receiver sheet 140 can be an ink jet generated imaged, that the print layer 300, first print layer 304 and second print layer 308 have a thickness between 1 and 75 microns, that the glossing sheet 220 can be made from a sheet of plastic 360 or from a recycled support layer 370, that the embossing image 190 formed on the embossing sheet 180 may contain characters of chop, speckle, dot, cross, combinations thereof or other formations well known in the art.

It is further contemplated that an embossed pre-press proof 230 could be formed on both side of a receiver stock 160 simultaneously or one side at a time.

The invention also contemplates that the images can be laser-generated images.

The invention is also a method for creating a dual embossed imaged pre-press proof comprising an imaged pre-press proof with a first side and a second side, and an image formed on at least one of said sides, creating a first embossing sheet by forming a first embossing impression and creating a second embossing sheet by forming a second embossing impression, disposing the first embossing sheet on the first side of the imaged pre-press proof and the second embossing sheet on the second side of the imaged pre-press proof and laminating the imaged pre-press proof with the first and second embossing sheets and removing the first and second embossing sheets forming a dual embossed imaged pre-press proof.

The dual embossed imaged pre-press proof formed by the above-method can have a resolution of between 1000 dpi and about 4000 dpi. Further, the dual embossed imaged pre-press proof formed by the method can have a resolution of between 1200 dpi and about 3600 dpi.

The invention is also a method for creating a reinforced dual embossed imaged pre-press proof involving creating an imaged pre-press proof made of an image formed, overlaying and laminating the imaged pre-press proof with a plastic cover sheeting forming and overlaid imaged pre-press proof having a first side and a second side; creating a first embossing sheet by forming a first embossing impression and creating a second embossing sheet by forming a second embossing impression; disposing the first embossing sheet on the first side of the overlaid imaged pre-press proof and the second embossing sheet on the second side of the overlaid imaged pre-press proof and laminating the overlaid imaged pre-press proof with the first and second embossing sheets; and removing the first and second embossing sheets forming a reinforced dual embossed imaged pre-press proof.

The reinforced dual embossed imaged pre-press proof formed by, the above-method can have a resolution of between 1000 dpi and about 4000 dpi. Further, the dual embossed imaged pre-press proof formed by the method can have a resolution of between 1200 dpi and about 3600 dpi. The image can also be a laser-generated image.

The invention is a method for creating a dual embossed glossy pre-press proof comprising creating a imaged receiver sheet comprising a support layer and a print layer comprising an image, laminating the imaged receiver sheet to a sheet of receiver stock, removing the support layer creating a pre-press proof, overlaying and laminating the pre-press proof with a glossing sheet, removing the glossing sheet forming a glossy pre-press proof having a first side and a second side, creating a first embossing sheet by forming a first embossing impression and creating a second embossing sheet by forming a second embossing impression; disposing the first embossing sheet on the first side of the glossy pre-press proof and the second embossing sheet on the second side of the glossy pre-press proof and laminating the overlaid imaged pre-press proof with the first and second embossing sheets; and removing the first and second embossing sheets forming a dual embossed glossy pre-press proof.

The dual embossed glossy pre-press proof formed by the above-method can have a resolution of between 1000 dpi and about 4000 dpi. Further, the dual embossed imaged pre-press proof formed by the method can have a resolution of between 1200 dpi and about 3600 dpi. The image can also be a laser-generated image.

The invention is a method for creating a dual embossed glossy pre-press proof comprising laminating a pre-laminate sheet consisting of a first print layer and a first support layer to a receiver stock; removing the first support layer forming a prelaminated receiver stock; creating a imaged receiver sheet comprising a second support layer and a second print layer comprising an image; laminating the imaged receiver sheet to the prelaminated receiver stock; removing the second support layer creating a pre-laminated pre-press proof; overlaying and laminating a glossing sheet to the prelaminated pre-press proof; removing the glossing sheet forming a prelaminated glossy pre-press proof having a first side and a second side; creating a first embossing sheet by forming a first embossing impression and creating a second embossing sheet by forming a second embossing impression; disposing the first embossing sheet on the first side of the prelaminated glossy pre-press proof and the second embossing sheet on the second side of the prelaminated glossy pre-press proof and laminating the prelaminated pre-press proof with the first and second embossing sheets; and removing the first and second embossing sheets forming a dual embossed glossy pre-press proof.

The dual embossed glossy pre-press proof formed by the above-method can have a resolution of between 1000 dpi and about 4000 dpi. Further, the dual embossed imaged pre-press proof formed by the method can have a resolution of between 1200 dpi and about 3600 dpi. The image can also be a laser-generated image.

The method can also include where the first and the second embossing impressions are identical. At least one of said embossing sheets can be chop, speckle, dots, crosses and combinations thereof. The imaged pre-press proof can also be a monochrome image and/or a multi-colored image. The image is the method can be an ink jet generated image and/or a laser generated image.

The invention has been described in detail with particular reference to certain preferred embodiments thereof, but it will be understood that variations and modifications can be effected within the scope of the invention.

### Parts List

10. Laminator

20. Entrance table

30. Exit table

40. Entrance slot

50. Pressure lever

60. Top cover

70. Right side cover

80. Left side cover

90. Control panel

100. Lamination base

110. Endless belts

120. Upper lamination roller

130. Lower lamination roller

140. Imaged receiver sheet

145. Support layer

150. First support layer

160. Receiver Stock

170. Second support layer

180. Embossing Sheet

190. Embossing Image

200. Pre-press proof

220. Glossing Sheet

230. Embossed pre-press proof

240. Pre-laminate sheet

250. Pre-laminated pre-press proof

260. Pre-laminated glossy pre-press proof

270. Release layer

274. First release layer

278. Second release layer

280. Aluminized layer

290. Image

300. Print layer

304. First print layer

310. Support base

314. First support base

318. Second support base

320. Plastic cover sheet

330. Overlaid pre-press proof

340. Glossy pre-press proof

350. Pre-laminated receiver stock

What is claimed is:

1. A method for creating an embossed imaged pre-press proof comprising:
a. creating a imaged pre-press proof comprising an image formed thereon;
b. creating an embossing sheet comprising an embossing impression formed thereon;
c. embossing at least one side of the imaged pre-press proof by overlaying and laminating said imaged pre-press proof with the embossing sheet; and
d. removing the embossing sheet forming an embossed imaged pre-press proof.

2. The method of claim 1, wherein said embossing sheet comprises a member of the group: chop, speckles, dots, crosses and combinations thereof.

3. The method of claim 1, wherein the imaged pre-press proof comprises a monochrome image.

4. The method of claim 1, wherein the imaged pre-press proof comprises a multi-colored image.

5. The method of claim 1, wherein the image is an ink jet generated image.

6. The method of claim 1, wherein the image is a laser generated image.

7. An embossed imaged pre-press proof with a resolution of between 1000 dpi and about 4000 dpi formed by the method of claim 1.

8. An embossed imaged pre-press proof with a resolution of between 1200 dpi and about 3600 dpi formed by the method of claim 1.

9. A method for creating a dual embossed imaged pre-press proof comprising:
a. creating an imaged pre-press proof with a first side and a second side and an image formed on at least one of said sides;
b. creating a first embossing sheet by forming a first embossing impression thereon, and creating a second embossing sheet by forming a second embossing impression thereof;
c. disposing the first embossing sheet on the first side of the imaged pre-press proof and the second embossing sheet on the second side of the imaged pre-press proof and laminating said imaged pre-press proof with the first and second embossing sheets; and
d. removing the first and second embossing sheets forming a dual embossed imaged pre-press proof.

10. The method of claim 9, wherein the first and the second embossing impressions are identical.

11. The method of claim 9, wherein at least one of said embossing sheets comprises a member of the group consisting of: chop, speckle, dots, crosses and combinations thereof.

12. The method of claim 9, wherein the imaged pre-press proof comprises a monochrome image.

13. The method of claim 9, wherein the imaged pre-press proof comprises a multi-colored image.

14. The method of claim 9, wherein the image is an ink jet generated image.

15. The method of claim 9, wherein the image is a laser generated image.

16. A dual embossed imaged pre-press proof with a resolution of between 1000 dpi and about 4000 dpi formed by the method of claim 9.

17. A dual embossed imaged pre-press proof with a resolution of between 1200 dpi and about 3600 dpi formed by the method of claim 9.

18. A method for creating a reinforced embossed imaged pre-press proof comprising:
a. creating an imaged pre-press proof comprising an image formed on a first side;
b. overlaying and laminating a plastic cover sheet on said imaged pre-press proof forming an overlaid imaged pre-press proof;
c. forming an embossing sheet comprising an embossed impression thereon;
d. overlaying and laminating the embossing sheet on said overlaid imaged pre-press proof; and
e. removing the embossing sheet forming a reinforced embossed imaged pre-press proof.

19. The method of claim 18, wherein said embossing sheet comprises a member of the group consisting of chop, speckle, dots, crosses and combinations thereof.

20. The method of claim 18, wherein the imaged pre-press proof comprises a monochrome image.

21. The method of claim 18, wherein the imaged pre-press proof comprises a multi-colored image.

22. The method of claim 18, wherein the image is an ink jet generated image.

23. The method of claim 18, wherein the image is a laser generated image.

24. The method of claim 18, wherein the imaged pre-press proof is a dual sided pre-press proof.

25. A reinforced embossed imaged pre-press proof with a resolution of between 1000 dpi and about 4000 dpi formed by the method of claim 18.

26. A reinforced embossed imaged pre-press proof with a resolution of between 1200 dpi and about 3600 dpi formed by the method of claim 18.

27. A method for creating a reinforced dual embossed imaged pre-press proof comprising:
a. creating an imaged pre-press proof comprising an image formed thereon;
b. overlaying and laminating said imaged pre-press proof with a plastic cover sheeting forming and overlaid imaged pre-press proof having a first side and a second side;
c. creating a first embossing sheet by forming a first embossing impression thereon, and creating a second embossing sheet by forming a second embossing impression thereof;
d. disposing the first embossing sheet on the first side of the overlaid imaged pre-press proof and the second embossing sheet on the second side of the overlaid imaged pre-press proof and laminating said overlaid imaged pre-press proof with the first and second embossing sheets; and
e. removing the first and second embossing sheets forming a reinforced dual embossed imaged pre-press proof.

28. The method of claim 27, wherein the first and the second embossing impressions are identical.

29. The method of claim 27, wherein at least one of said embossing sheets comprises a member of the group consisting of: chop, speckle, dots, crosses and combinations thereof.

30. The method of claim 27, wherein the imaged pre-press proof comprises a monochrome image.

31. The method of claim 27, wherein the imaged pre-press proof comprises a multi-colored image.

32. The method of claim 27, wherein the image is an ink jet generated image.

33. The method of claim 27, wherein the image is a laser generated image.

34. A reinforced dual embossed imaged pre-press proof with a resolution of between 1000 dpi and about 4000 dpi formed by the method of claim 27.

35. A reinforced dual embossed imaged pre-press proof with a resolution of between 1200 dpi and about 3600 dpi formed by the method of claim 27.

36. A method for creating an embossed glossy pre-press proof comprising:
a. creating a imaged receiver sheet comprising: a support layer and a print layer comprising an image;
b. laminating said imaged receiver sheet to a sheet of receiver stock;
c. removing said support layer creating a pre-press proof,
d. overlaying and laminating said pre-press proof with a glossing sheet;
e. removing said glossing sheet forming a glossy pre-press proof;
f. creating an embossing sheet comprising an embossing impression formed thereon;
g. embossing at least one side of the glossy pre-press proof by overlaying and laminating said glossy pre-press proof with the embossing sheet; and
h. removing the embossing sheet forming an embossed glossy pre-press proof.

37. The method of claim 36, wherein said embossing sheet comprises a member of the group: chop, speckles, dots, crosses and combinations thereof.

38. The method of claim 36, wherein the image comprises a monochrome image.

39. The method of claim 36, wherein the image comprises a multi-colored image.

40. The method of claim 36, wherein the image is an ink jet generated image.

41. The method of claim 36, wherein the image is a laser generated image.

42. An embossed glossy pre-press proof with a resolution of between 1000 dpi and about 4000 dpi formed by the method of claim 36.

43. An embossed glossy pre-press proof with a resolution of between 1200 dpi and about 3600 dpi formed by the method of claim 36.

44. A method for creating a dual embossed glossy pre-press proof comprising:
a. creating a imaged receiver sheet comprising: a support layer and a print layer comprising an image;
b. laminating said imaged receiver sheet to a sheet of receiver stock;
c. removing said support layer creating a pre-press proof;
d. overlaying and laminating said pre-press proof with a glossing sheet;
e. removing said glossing sheet forming a glossy pre-press proof having a first side and a second side;
f. creating a first embossing sheet by forming a first embossing impression thereon, and creating a second embossing sheet by forming a second embossing impression thereof;
g. disposing the first embossing sheet on the first side of the glossy pre-press proof and the second embossing sheet on the second side of the glossy pre-press proof and laminating said overlaid imaged pre-press proof with the first and second embossing sheets; and
h. removing the first and second embossing sheets forming a dual embossed glossy pre-press proof.

45. The method of claim 44, wherein the first and the second embossing impressions are identical.

46. The method of claim 44, wherein at least one of said embossing sheets comprises a member of the group consisting of: chop, speckle, dots, crosses and combinations thereof.

47. The method of claim 44, wherein the imaged receiver sheet comprises a monochrome image.

48. The method of claim 44, wherein the imaged receiver sheet comprises a multi-colored image.

49. The method of claim 44, wherein the image is an ink jet generated image.

50. The method of claim 44, wherein the image is a laser generated image.

51. A dual embossed glossy pre-press proof with a resolution of between 1000 dpi and about 4000 dpi formed by the method of claim 44.

52. A dual embossed glossy pre-press proof with a resolution of between 1200 dpi and about 3600 dpi formed by the method of claim 44.

53. A method for creating an embossed pre-press proof comprising:
a. laminating a pre-laminate sheet consisting of a first print layer and a first support layer to a receiver stock;
b. removing the first support layer forming a prelaminated receiver stock;
c. creating a imaged receiver sheet comprising: a second support layer and a second print layer comprising an image;
d. laminating said imaged receiver sheet to said prelaminated receiver stock;
e. removing said second support layer creating a prelaminated pre-press proof;
f. overlaying and laminating a glossing sheet to said prelaminated pre-press proof;
g. removing said glossing sheet forming a prelaminated glossy pre-press proof;
h. creating an embossing sheet comprising an embossing impression formed thereon;
i. embossing at least one side of the prelaminated glossy pre-press proof by overlaying and laminating said prelaminated glossy pre-press proof with the embossing sheet; and
j. removing the embossing sheet forming an embossed glossy pre-press proof.

54. The method of claim 53, wherein said embossing sheet comprises a member of the group: chop, speckles, dots, crosses and combinations thereof.

55. The method of claim 53, wherein the image comprises a monochrome image.

56. The method of claim 53, wherein the image comprises a multi-colored image.

57. The method of claim 53, wherein the image is an ink jet generated image.

58. The method of claim 53, wherein the image is a laser generated image.

59. An embossed sided glossy pre-press proof with a resolution of between 1000 dpi and about 4000 dpi formed by the method of claim 52.

60. An embossed glossy pre-press proof with a resolution of between 1200 dpi and about 3600 dpi formed by the method of claim 52.

61. A method for creating a dual embossed glossy pre-press proof comprising:
a. laminating a pre-laminate sheet consisting of a first print layer and a first support layer to a receiver stock;
b. removing the first support layer forming a prelaminated receiver stock;
c. creating a imaged receiver sheet comprising: a second support layer and a second print layer comprising an image;
d. laminating said imaged receiver sheet to said prelaminated receiver stock;
e. removing said second support layer creating a prelaminated pre-press proof;
f. overlaying and laminating a glossing sheet to said prelaminated pre-press proof;
g. removing said glossing sheet forming a prelaminated glossy pre-press proof having a first side and a second side;
h. creating a first embossing sheet by forming a first embossing impression thereon, and creating a second embossing sheet by forming a second embossing impression thereof;
i. disposing the first embossing sheet on the first side of the prelaminated glossy pre-press proof and the second embossing sheet on the second side of the prelaminated glossy pre-press proof and laminating said prelaminated pre-press proof with the first and second embossing sheets; and
j. removing the first and second embossing sheets forming a dual embossed glossy pre-press proof.

62. The method of claim 61, wherein the first and the second embossing impressions are identical.

63. The method of claim 61, wherein at least one of said embossing sheets comprises a member of the group consisting of: chop, speckle, dots, crosses and combinations thereof.

64. The method of claim 61, wherein the image comprises a monochrome image.

65. The method of claim 61, wherein the image comprises a multi-colored image.

66. The method of claim 61, wherein the image is an ink jet generated image.

67. The method of claim 61, wherein the image is a laser generated image.

68. A dual embossed glossy pre-press proof with a resolution of between 1000 dpi and about 4000 dpi formed by the method of claim 61.

69. A dual embossed glossy pre-press proof with a resolution of between 1200 dpi and about 3600 dpi formed by the method of claim 61.
